(19) United States
(12) Patent Application Publication
(10) Pub. No.: US 2024/0002580 A1
(43) Pub. Date: Jan. 4, 2024

(54) AROMATIC POLYESTER POLYOL COMPOUND

(71) Applicant: Huntsman International LLC, The Woodlands, TX (US)

(72) Inventors: Kai XI, The Woodlands, TX (US); Paul MACKEY, The Woodlands, TX (US); Lifeng WU, The Woodlands, TX (US); Sachchida SINGH, The Woodlands, TX (US)

(21) Appl. No.: 18/039,302

(22) PCT Filed: Dec. 3, 2021
(86) PCT No.: PCT/US2021/061780

§ 371 Date: May 30, 2023

Related U.S. Application Data
(60) Provisional application No. 63/120,993, filed on Dec. 3, 2020.

(51) Int. Cl. C08G 18/42; C08G 63/672; C08G 63/85; C08J 9/04

(52) U.S. Cl. CPC C08G 18/4286; C08G 63/672; C08G 63/85; C08J 9/04; C08J 2375/06

(57) ABSTRACT

A method for making an aromatic polyester polyol compound, wherein the method comprises reacting at esterification reaction conditions a reactive mixture comprising the following components: (i) an aromatic acid compound; (ii) an aliphatic diol compound; (iii) a dialkylol alkanoic acid compound; (iv) optionally, a hydrophobic compound, a polyhydroxy compound comprising at least three hydroxyl groups, or combinations thereof, and wherein the aromatic polyester polyol compound is liquid at 25° C. and has a hydroxy value ranging from about 30 to about 600.

### CROSS-REFERENCE TO RELATED APPLICATIONS

This application claims priority to U.S. Provisional Application No. 63/120,993 filed Dec. 3, 2020. The noted application(s) are incorporated herein by reference.

### BACKGROUND

### Field

The present disclosure relates generally to an aromatic polyester polyol compound and methods of manufacturing thereof.

### Background

Polyurethane (“PU”) and polyisocyanurate (“PIR”) based foam products are widely used in the building construction and industrial industries because of their superior sealing and insulative properties when compared to other solutions used in those industries. These foam products are formed from the reaction of an isocyanate compound and an isocyanate reactive compound where the reaction may or may not occur in the presence of a catalyst or other additives.

Formulators who formulate a PU or PIR based foam compositions often have specific requirements related to the isocyanate reactive compounds used in their compositions. These requirements include hydroxy number, functionality, viscosity, aromatic content, blowing agent solubility, and other properties. The formulator's selection of the isocyanate reactive compound will depend on a variety of factors such as processability of the foam composition and the desired mechanical and structural properties of the resulting PU or PIR foam product.

Accordingly, there remains a need for a polyester polyol compound having certain properties that might be desirable of PU or PIR based foam compositions.

### DETAILED DESCRIPTION

As used herein, “aromatic polyester polyol composition” means the reactive mixture comprising Components (i) to (iv).

As used herein, “bio-renewable content” means the proportion of renewable materials from biological sources in the aromatic polyester polyol compound compared to the total mass of the aromatic polyester polyol compound, which may be measured using ASTM D6866.

As used herein, “hydrophobic compound” means a compound or mixture of compounds containing at least non-polar organic moiety. The hydrophobic compound is generally water insoluble and contains at least one functional group capable of being esterified or transesterified (e.g., a monocarboxylic acid group, a monocarboxylic acid ester group, a hydroxyl group, or combinations thereof).

As used herein, “includes” and like terms means “including without limitation.”

As used herein, “monocarboxylic acid group” and “monocarboxylic acid ester group” means that the carboxylic acid moieties present in the hydrophobic compound are monoacids.

As used herein, “plurality” means two or more while the term “number” means one or an integer greater than one.

As used herein, “recycled content” means the proportion of recycled aromatic acid/ester and recycled aliphatic diol compounds in the aromatic polyester polyol compound compared to the total mass of the aromatic polyester polyol compound.

Unless otherwise expressly specified, all numbers, such as those expressing values, ranges, amounts or percentages, should be read as if prefaced by the word “about” even if the term does not expressly appear. Plural encompasses singular and vice versa.

When referring to any numerical range of values, such ranges are understood to include each and every number and/or fraction between the stated range minimum and maximum. For example, a range of “1 to 10” or “1-10” is intended to include all sub-ranges between (and including) the recited minimum value of 1 and the recited maximum value of 10, that is, having a minimum value equal to or greater than 1 and a maximum value of equal to or less than 10.

Unless otherwise stated herein, reference to any compounds shall also include any isomers (e.g., stereoisomers) of such compounds.

Unless otherwise stated herein, reference to any compounds shall also include any isomers (e.g., stereoisomers) of such compounds.

Unless otherwise stated herein, “molecular weight” means weight average molecular weight (M_{w}) as determined by Gel Permeation Chromatography.

Method of making an Aromatic Polyester Polyol Compound

The present disclosure is directed to a method of making an aromatic polyester polyol compound. The method comprises reacting at esterification reaction conditions a reactive mixture comprising the following components:
(i) an aromatic acid compound;
(ii) an aliphatic diol compound;
(iii) a dialkylol alkanoic acid compound of Formula I:

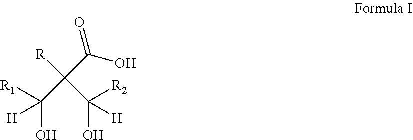

wherein R is hydrogen, C₁ to C₈ alkyl (straight-chain or branched), C₁ to C₈ hydroxyalkyl, C₁ to C₁₂ aromatic, or C₁ to C₁₂ cyclic aliphatic, and wherein R₁, R₂ are each independently hydrogen, methyl, or ethyl; and
(iv) optionally, a polyhydroxy compound comprising at least three hydroxyl groups, a hydrophobic compound, or combinations thereof, and
   wherein the aromatic polyester polyol compound is liquid at 25° C. and has a hydroxy value ranging from 30 to 600.

The aromatic polyester polyol compound of the present disclosure is made by placing Components (i) to (iv), which are described in greater detail below, into a reaction vessel and subjecting the reactive mixture to esterification/transesterification reaction conditions at temperatures ranging from 50° C. to 300° C. for a time period ranging from 1 hour to 24 hours (e.g., 3 hours to 10 hours). In some embodiments, two or more of Components (i) to (iv) may be pre-reacted with one another to form an intermediate product. The intermediate product can then be introduced into a reaction vessel with the remaining components and subjected to esterification/transesterification reaction conditions to form the aromatic polyester polyol compound. Any volatile by-products of the reaction, such as water or methanol, can be removed from the process thereby forcing the ester interchange reaction to completion. While the synthesis of the aromatic polyester polyol compound may take place under reduced or increased pressure, the reaction is generally carried out near atmospheric pressure conditions.

An esterification/transesterification catalyst may be used during synthesis to increase the rate of reaction. Examples of suitable esterification/transesterification catalyst include tin catalysts (e.g., FAST Cat catalyst available from Arkema, Inc.), titanium catalyst (e.g., TYZOR TBT catalyst, TYZOR TE catalyst both available from Dork Ketal Chemical LLC), alkali catalysts (e.g., sodium hydroxide, potassium hydroxide, sodium and potassium alkoxides), acid catalyst (e.g., sulfuric acid, phosphoric acid, hydrochloric acid, sulfonic acid), enzymes, or combinations thereof. The esterification/transesterification catalyst can be present in an amount ranging from 0.001% to 0.2% by weight of based on the total weight of the aromatic polyester polyol composition.

Component (i): Aromatic Acid Compound

Suitable aromatic acid compounds that may be used as Component (i) include terephthalic acid, phthalic anhydride, phthalic acid, isophthalic acid, 2,6-naphthalene dicarboxylic acid, trimellitic anhydride, hemimellitic anhydride, pyromellitic dianhydride, mellophanic dianhydride, methyl esters of phthalic, isophthalic, terephthalic acid, and 2,6-naphthalene dicarboxylic acid, or combinations thereof.

Other compounds that may be used as Component (i) also include more complex ingredients such as the side stream, waste, and/or scrap residues from the manufacture of the compounds listed above, the byproduct of aromatic carboxylic acid (BACA), or combinations thereof.

Yet other compounds that may be used as Component (i) include polyalkylene terephthalate polymers (e.g., polyethylene terephthalate (PET), polybutylene terephthalate (PBT), polytrimethylene terephthalate (PTT), glycol-modified polyethylene terephthalate (PETG)), copolymers of terephthalic acid and 1,4-cyclohexanedimethanol (PCT), polyethylene napthalate (PEN), or combinations thereof.

Any of these polymers may be obtained from recycled or used objects that have been discarded including photographic films, X-ray films, synthetic fibers, plastic bottles or other related containers widely used in the soft drink industry, recycled materials generated during the production of other products, such as those made from polyalkylene terephthalate polymers, or combinations thereof. For example, rPET and/or rPTT can be derived from the post-consumer waste stream of plastic bottles or other related containers as well as from post-industrial or post-consumer carpet. In these embodiments, the rPET may contain minor proportion of organic and/or inorganic foreign matters (e.g., paper, dyes, other plastics, glass, or metal). In certain embodiments, rPET and/or rPTT can either be in flake or pelletized form. Oligomeric materials derived from PET and/or PTT may also be used. These materials can manufactured by reacting PET and/or PTT with one or more glycols, optionally in the presence of a catalyst, under reactive condition that can partially depolymerize the PET and/or PTT.

Component (i) may be present in an amount ranging from 5% to 70% (e.g., 10% to 50% or 15% to 45%) by weight based on the total weight of the aromatic polyester polyol composition.

Component (ii): Aliphatic Diol Compound

Suitable aliphatic diol compounds that may be used as Component (ii) include compounds having the following structure:

OH—R—OH

wherein R is a divalent radical selected from the group consisting of: (i) alkylene radicals containing 2 to 12 carbon atoms (with or without alkyl branches); or (ii) radicals of the following structure:

—[(R′O)ₙ—R′]—

wherein R′ is an alkylene radical containing 2 to 4 carbon atoms and n is an integer from 1 to 10.

Examples of suitable aliphatic diol compounds that may be used as Component (ii) include ethylene glycol; diethylene glycol; triethylene glycol; tetraethylene glycol; propylene glycol; dipropylene glycol; tripropylene glycol; butylene glycol; 1,4 butanediol; neopentyl glycol; poly(oxyalkylene) polyols containing 2 to 4 alkylene radicals derived by the condensation of ethylene oxide, propylene oxide, or combinations thereof, 2-methyl-2,4-pentanediol; 1,6-hexanediol; 1,2-cyclohexanediol; or combinations thereof.

Component (ii) may be present in an amount ranging from 5% to 60% (e.g., 10% to 50% or 15% to 45%) by weight based on the total weight of the aromatic polyester polyol composition.

Component (iii): Dialkylol Alkanoic Acid

The dialkylol alkanoic acid compound used as Component (III) has the structure shown in Formula I:

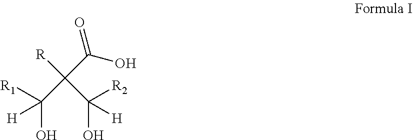

wherein R is hydrogen, C₁ to C₈ alkyl (straight-chain or branched), C₁ to C₈ hydroxyalkyl, C₁ to C₁₂ aromatic, or C₁ to C₁₂ cyclic aliphatic. Examples include hydrogen, methyl, ethyl, isopropyl, hydroxymethyl, hydroxyethyl, phenyl, tolyl, naphthyl, cyclopentyl, cyclohexyl. Preference is given to methyl, ethyl, propyl, butyl, phenyl, and tolyl.

wherein R1, R2 are each independently hydrogen, C₁ to C₈ alkyl (straight-chain or branched). Examples include hydrogen, methyl, ethyl, iso-propyl, n-propyl, n-butyl, isobutyl, sec-butyl, tert-butyl, n-pentyl, n-hexyl, n-heptyl, n-octyl.

Examples of dialkylol alkanoic acid compounds that may be used as Component (iii) include 2,2-bis(hydroxymethyl)propionic acid (DMPA); 2,2-bis(hydroxymethyl)butanoic acid (DMBA); 2,2-bis(hydroxymethyl)pentanoic acid (DMPTA); 2-2-bis(hydroxymethyl)hexanoic acid (DMHA); 2,2,2-trimethylol acetic acid (TMAA); and 2,2-bis(hydroxymethyl)benzoic acid; 2,2-bis(hydroxymethyl)toluic acid, or combinations thereof.

Component (iii) may be present in an amount ranging from 0.1% to 30% (e.g., 0.5% to 25% or 1% to 15%) by weight based on the total weight of the aromatic polyester polyol composition.

Component (iv): Optional Additives

Component (iv) can contain a polyhydroxy compound comprising at least three hydroxyl groups, a hydrophobic compound, or combinations thereof.

Suitable polyhydroxy compounds that may be used as Component (iv) include low molecular weight compounds containing 3 to 8 hydroxy groups. Examples of suitable polyhydroxy compounds include glycerin; alkoxylated glycerin; 1,1,1-trimethylolpropane, 1,1,1-trimethylolethane; pentaerythritol; dipentaerythritol; sucrose; alkoxylated sucrose; methyl glucoside; alkoxylated methyl glucoside; glucose; alkoxylated glucose; fructose; alkoxylated fructose; sorbitol; alkoxylated sorbitol; lactose; alkoxylated lactose; mannitol; diglycerol; erythritol; xylitol; or combinations thereof.

In certain embodiments, the hydrophobic compounds that may be used as Component (iv) include those compounds that are not derived from aromatic acids. Examples of suitable hydrophobic compounds include carboxylic acids (e.g., fatty acid compounds such as caproic, caprylic, 2-ethylhexanoic, capric, lauric, myristic, palmitic, stearic, oleic, linoleic, linolenic, and ricinoleic compounds); lower alkanol esters of carboxylic acids (e.g., fatty acid methyl ester compounds such as methyl caproate, methyl caprylate, methyl caprate, methyl laurate, methyl myristate, methyl palmitate, methyl oleate, methyl stearate, methyl linoleate, and methyl linolenate); fatty acid alkanolamides (e.g., tall oil fatty acid diethanolamide, lauric acid diethanolamide, and oleic acid monoethanolamide); triglycerides (e.g., fats and oils such as castor oil, coconut (including cochin) oil, corn oil, cottonseed oil, linseed oil, olive oil, palm oil, palm kernel oil, peanut oil, soybean oil, sunflower oil, tall oil, tallow, and derivatives of natural oil or functionalized, such as epoxidized, natural oil); alkyl alcohols (e.g., alcohols containing 4 to 18 carbon atoms per molecule such as decyl alcohol, oleyl alcohol, cetyl alcohol, isodecyl alcohol, tridecyl alcohol, lauryl alcohol, and mixed C₁₂-C₁₄ alcohol); or combinations thereof.

Component (iv) may be present in an amount ranging from 0% to 30% (e.g., 0% to 20% or 0% to 15%) by weight based on the total weight of the aromatic polyester polyol composition.

Other Additives

The aromatic polyester polyol reactive mixture can also contain minor amounts of dyes, antioxidants, ultraviolet stabilizers, acid scavengers, or combinations thereof. These additives may be present in an amount of ≤1% (e.g., ≤0.5%) by weight based on the total weight of the aromatic polyester polyol composition.

In certain embodiments, a non-ionic surfactant compound may also be used as an additive. These non-ionic surfactants may contain one or more hydrophobic moieties and one or more hydrophilic moieties. However, the non-ionic surfactants do not contain any moieties that dissociate into cations or anions when subjected to an aqueous solution or dispersion. While nearly any non-ionic surfactant compound may be used, a suitable surfactant is a polyoxyalkylene surfactant compound containing an average of 4 to 200 individual oxyalkylene groups per molecule wherein the oxyalkylene group is selected from the group consisting of oxyethylene, oxypropylene, or combinations thereof. The non-ionic surfactant compound can be present in an amount ranging from 0% to 20% by weight based on the total weight of the aromatic polyester composition.

Aromatic Polyester Polyol Characteristics

The aromatic polyester polyol compound of the present disclosure exhibits compatibility with components that are typically used in PU and PIR foam compositions such as hydrocarbon blowing agents (e.g., pentane, HFC based blowing agents) while having low viscosity, high functionality, and high aromatic content properties.

In certain embodiments, the aromatic polyester polyol compound has a calculated number average functionality ranging from 1.7 to 4 (e.g., 2 to 3.5 or 2.2 to 3) and an average hydroxyl number ranging from 30 to 600 (e.g., 50 to 500 or 100 to 450). It is noted that the hydroxyl number does take into account that free glycols may be present. The hydroxyl number of the aromatic polyester polyol can be measured using ASTM-D4274.

In some embodiments, the viscosity of the aromatic polyester polyol compound ranges from 200 to 50,000 centipoises (cps) (e.g., 1,000 to at 20,000 or 1,500 to 10,000) at 25° C. as measured using a Brookfield DV-II viscometer. In certain embodiments, the viscosity of the aromatic polyester polyol compound is lower than a corresponding polyol compound made to the same hydroxy number, aromatic content, and calculated functionality but without the use of Component (iii).

In certain embodiments, the aromatic polyester polyol compound has a bio-renewable content of at least 10% (e.g., ≥25% or ≥40%) by weight based on the total weight of the aromatic polyester polyol compound. Suitable bio-renewable materials that may be used in the synthesis of the aromatic polyester polyol compound include plant derived natural oils and the fatty acid components of such oils. Bio-renewable content can be measured using ASTM D6866.

In some embodiments, the aromatic polyester polyol compound has a recycled content of at least 10% (e.g., ≥25% or ≥40%) by weight based on the total weight of the aromatic polyester polyol compound.

Modifications

While specific embodiments of the disclosure have been described in detail, it will be appreciated by those skilled in the art that various modifications and alternatives to those details could be developed considering the overall teachings of the disclosure. Accordingly, the arrangements disclosed herein are meant to be illustrative only and not limiting as to the scope of the disclosure which is to be given the full breadth of the claims appended and all equivalents thereof. Therefore, any of the features and/or elements which are listed above may be combined with one another in any combination and still be within the breadth of this disclosure.

### EXAMPLES

### Components:

DEG: Diethylene glycol available from Equistar Chemicals, LP.
DMBA: Dimethylolbutyric acid available from MilliporeSigma.
DMPA: Dimethylolpropionic acid available from MilliporeSigma.
Glycerin: Available from Terra Biochem LLC.
PE: Pentaerythriol available from Perstorp Polyols, Inc.
PTA: Purified terephthalic acid available from Grupo Petrotemex.
SBO: Refined soybean oil available from Archer Daniels Midland Company.
TEG: Triethylene glycol available from The Dow Chemical Company.
TTEG: Tetraethylene glycol available from The Dow Chemical Company.
TYZOR TE: Titanium (triethanolaminato) isopropoxide solution 80 wt % in isopropanol available from Dorf Ketal Specialty Catalyst LLC.

### Analysis and Testing:

The following terms are referred to in the Examples:

Acid number: a measurement of residue acid determined by standard titration techniques (e.g., ASTM D4662).

Aromatic content: Weight percent of benzene di-radicals in the final polyol product calculated from benzene ring containing raw material used in the polyol synthesis.

FN: Functionality of polyol is the average number of OH groups in each molecule defined as the ratio of a mole of OH groups and a mole of molecules in a certain quantity of polyol product calculated from the polyol raw material composition.

Hydrophobic content: Weight percentage of aliphatic chain radical in the final polyol product calculated from the hydrophobic compound raw material used in the polyol synthesis.

OH number: Hydroxyl number which is a measurement of the number of OH groups determined by standard titration techniques (e.g., ASTM D4274).

Viscosity: Dynamic viscosity measured using a Brookfield Viscometer (e.g., Brookfield DV-II viscometer).

Polyol-1 (Comparative)

264 g of PTA, 10.9 g of PE, 82 g of Glycerin, 110 g of TTEG, 139 g of TEG, 89 g of DEG, and 62 g of SBO were added to a 500 mL cylindrical glass reactor. Under a ˜ 0.3 to 0.5 liter per minute (LPM) flow of nitrogen, the reaction mixture was heated to 240° C. The temperature was then maintained at 240° C. and the condensation water was collected. When the head temperature dropped below 70° C. (˜4 hours later), 0.7 g of Tyzor TE was added. The reaction was then heated at 240° C. until the acid value was below 2.0 mg KOH/g (˜2 hours later). The reaction was then cooled to room temperature and the initial OH number was measured. DEG was then added to the reactor based on calculation to adjust the OH number to the calculated 350 mg KOH/g while blending the mixture at 80° C. for 30 minutes. The final Polyol-1 was then cooled to room temperature, and the acid number, OH number and viscosity were measured.

Polyol-1A (Inventive)

264 g of PTA, 8.1 g of DMPA, 89 g of Glycerin, 110 g of TTEG, 136 g of TEG, 89 g of DEG, and 62 g of SBO were added to a 500 mL cylindrical glass reactor. Under a ˜ 0.3 to 0.5 liter per minute (LPM) flow of nitrogen, the reaction mixture was heated to 240° C. The temperature was then maintained at 240° C. and the condensation water was collected. When the head temperature dropped below 70° C. (˜4 hours later), 0.7 g of Tyzor TE was added. The reaction was then heated at 240° C. until the acid value was below 2.0 mg KOH/g (˜2 hours later). The reaction was then cooled to room temperature and the initial OH number was measured. DEG was then added to the reactor based on calculation to adjust the OH number to the calculated 350 mg KOH/g while blending the mixture at 80° C. for 30 minutes. The final Polyol-1A was then cooled to room temperature, and the acid number, OH number and viscosity were measured.

Polyol-1B (Inventive)

264 g of PTA, 24.3 g of DMPA, 78 g of Glycerin, 90 g of TTEG, 111 g of TEG, 132 g of DEG, and 62 g of SBO were added to a 500 mL cylindrical glass reactor. Under a ˜ 0.3 to 0.5 liter per minute (LPM) flow of nitrogen, the reaction mixture was heated to 240° C. The temperature was then maintained at 240° C. and the condensation water was collected. When the head temperature dropped below 70° C. (˜4 hours later), 0.7 g of TYZOR TE was added. The reaction was then heated at 240° C. until the acid value was below 2.0 mg KOH/g (˜2 hours later). The reaction was then cooled to room temperature and the initial OH number was measured. DEG was then added to the reactor based on calculation to adjust the OH number to the calculated 350 mg KOH/g while blending the mixture at 80° C. for 30 minutes. The final Polyol-1B was then cooled to room temperature, and the acid number, OH number and viscosity were measured.

Polyol-1C (Inventive)

264 g of PTA, 23.9 g of DMBA, 80 g of Glycerin, 90 g of TTEG, 111 g of TEG, 130 g of DEG, and 62 g of SBO were added to a 500 mL cylindrical glass reactor. Under a ˜ 0.3 to 0.5 liter per minute (LPM) flow of nitrogen, the reaction mixture was heated to 240° C. The temperature was then maintained at 240° C. and the condensation water was collected. When the head temperature dropped below 70° C. (˜4 hours later), 0.7 g of TYZOR TE was added. The reaction was then heated at 240° C. until the acid value was below 2.0 mg KOH/g (˜2 hours later). The reaction was then cooled to room temperature and the initial OH number was measured. DEG was then added to the reactor based on calculation to adjust the OH number to the calculated 350 mg KOH/g while blending the mixture at 80° C. for 30 minutes. The final Polyol-1C was then cooled to room temperature, and the acid number, OH number, and viscosity were measured.

Polyol-2 (Comparative)

259 g of PTA, 21.2 g of PE, 77 g of Glycerin, 108 g of TTEG, 167 g of TEG, 64 g of DEG, and 61 g of SBO were added to a 500 mL cylindrical glass reactor. Under a ˜ 0.3 to 0.5 liter per minute (LPM) flow of nitrogen, the reaction mixture was heated to 240° C. The temperature was then maintained at 240° C. and the condensation water was collected. When the head temperature dropped below 70° C. (˜4 hours later), 0.7 g of TYZOR TE was added. The reaction was then heated at 240° C. until the acid value was below 2.0 mg KOH/g (˜2 hours later). The reaction was then cooled to room temperature and the initial OH number was measured. DEG was then added to the reactor based on calculation to adjust the OH number to the calculated 350 mg KOH/g while blending the mixture at 80° C. for 30 minutes. The final Polyol-2 was then cooled to room temperature, and the acid number, OH number, and viscosity were measured.

Polyol-2A (Inventive)

266 g of PTA, 8.1 g of DMPA, 102 g of Glycerin, 118 g of TTEG, 136 g of TEG, 67 g of DEG, and 61 g of SBO were added to a 500 mL cylindrical glass reactor. Under a ˜ 0.3 to 0.5 liter per minute (LPM) flow of nitrogen, the reaction mixture was heated to 240° C. The temperature was then maintained at 240° C. and the condensation water was collected. When the head temperature dropped below 70° C. (˜4 hours later), 0.7 g of TYZOR TE was added. The reaction was then heated at 240° C. until the acid value was below 2.0 mg KOH/g (˜2 hours later). The reaction was then cooled to room temperature and the initial OH number was measured. DEG was then added to the reactor based on calculation to adjust the OH number to the calculated 350 mg KOH/g while blending the mixture at 80° C. for 30 minutes. The final Polyol-2A was then cooled to room temperature, and the acid number, OH number, and viscosity were measured.

Polyol-2B (Inventive)

265 g of PTA, 24.3 g of DMPA, 91 g of Glycerin, 93 g of TTEG, 133 g of TEG, 93 g of DEG, and 61 g of SBO were added to a 500 mL cylindrical glass reactor. Under a ˜ 0.3 to 0.5 liter per minute (LPM) flow of nitrogen, the reaction mixture was heated to 240° C. The temperature was then maintained at 240° C. and the condensation water was collected. When the head temperature dropped below 70° C. (˜4 hours later), 0.7 g of TYZOR TE was added. The reaction was then heated at 240° C. until the acid value was below 2.0 mg KOH/g (˜2 hours later). The reaction was then cooled to room temperature and the initial OH number was measured. DEG was then added to the reactor based on calculation to adjust the OH number to the calculated 350 mg KOH/g while blending the mixture at 80° C. for 30 minutes. The final Polyol-2B was then cooled to room temperature, and the acid number, OH number, and viscosity were measured.

Summary of Polyol Properties

TABLE 1

| | Polyol- | Polyol- | Polyol- | Polyol- |
|---|---|---|---|---|
| Polyols | 1 | 1A | 1B | 1C |
| DMPA (per 100 parts | 0.0 | 1.15 | 3.47 | |
| final polyol) | | | | |
| DMBA (per 100 parts | 0.0 | | | 3.42 |
| final polyol) | | | | |
| Acid number (mg KOH/ | 0.8 | 1.0 | 1.4 | 0.8 |
| g) | | | | |
| OH number (mg KOH/g) | 350.8 | 349.6 | 352.0 | 347.5 |
| Functionality (number | 2.50 | 2.50 | 2.50 | 2.50 |
| based) | | | | |
| Hydrophobic content (%) | 7.14 | 7.10 | 7.06 | 7.09 |
| Aromatic content (%) | 17.29 | 17.25 | 17.22 | 17.27 |
| Viscosity (25° C., cPs) | 4,699 | 4,359 | 3,669 | 4,181 |

TABLE 2

| Polyols | Polyol-2 | Polyol-2A | Polyol-2B |
|---|---|---|---|
| DMPA (per 100 parts final polyol) | 0.00 | 1.15 | 3.43 |
| Acid number (mg KOH/g) | 1.1 | 0.8 | 1.1 |
| OH number (mg KOH/g) | 354.0 | 353.3 | 357.3 |
| Functionality (number based) | 2.56 | 2.60 | 2.58 |
| Hydrophobic content (%) | 6.97 | 7.02 | 6.96 |
| Aromatic content (%) | 16.97 | 17.41 | 17.18 |
| Viscosity (25° C., cPs) | 5,939 | 5,419 | 4,799 |

As shown in Table 1 and Table 2, the inventive polyols have lower viscosities than the comparative polyols while maintaining similar properties (e.g., acid number, OH number, functionality, hydrophobic content and aromatic content) to the comparative polyols. The lower viscosity of the inventive polyols improves the ability to mix these compounds with other components used to make making polyurethane and polyisocyanurate based foam. Better mixing typically leads to improved properties (e.g., dimensional stability, thermal conductivity, compressive strength) in the foam products.

1. A method for making an aromatic polyester polyol compound, wherein the method comprises reacting at esterification reaction conditions a reactive mixture comprising the following components:
(i) an aromatic acid compound;
(ii) an aliphatic diol compound;
(iii) a dialkylol alkanoic acid compound of Formula I: 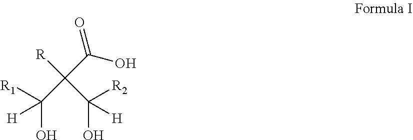
wherein R is hydrogen, C₁ to C₈ alkyl (straight-chain or branched), C₁ to C₈ hydroxyalkyl, C₁ to C₁₂ aromatic, or C₁ to C₁₂ cyclic aliphatic, and wherein R₁, R₂ are each independently hydrogen, C₁ to C alkyl (straight-chain or branched); and
(iv) optionally, a hydrophobic compound, a polyhydroxy compound comprising at least three hydroxyl groups, or combinations thereof; and
wherein the aromatic polyester polyol compound is liquid at 25° C. and has a hydroxy value ranging from about 30 to about 600.

2. The method according to claim 1, wherein at least one of R₁ and R₂ is hydrogen.

3. The method according to claim 1, wherein R is hydrogen, ethyl, methyl, hydroxymethyl, C₁ to C₃ alkyl, or phenyl.

4. The method according to claim 1, wherein Component (iii) comprises 2,2-bis(hydroxymethyl)propionic acid (DMPA); 2,2-bis(hydroxymethyl)butanoic acid (DMBA); 2,2-bis(hydroxymethyl)pentanoic acid (DMPTA); 2,2-bis(hydroxymethyl)hexanoic acid (DMHA); 2,2,2-trimethylol acetic acid (TMAA); and 2,2-bis(hydroxymethyl)phenylacetic acid and 2,2-bis(hydroxymethyl) tolylacetic acid; or combinations thereof.

5. The method according to claim 1, wherein the aromatic polyester polyol compound has a bio-renewable and/or recycled content of at least 10% by weight based on the total weight of the aromatic polyester polyol.

6. (canceled)

7. The method according to claim 1, wherein the viscosity of the aromatic polyester polyol compound ranges from about 200 to about 150,000 centipoises at 25° C.

8. The method according to claim 1, wherein the acid value of the aromatic polyester polyol compound ranges from about 0.1 mg of KOH/g to about 10 mg of KOH/g.

9. The method according to claim 1, wherein the viscosity of the aromatic polyester polyol compound is lower than a corresponding polyol compound made to the same hydroxy number, aromatic content, and calculated functionality but without the use of Component (iii).

10. The method according to claim 1, wherein the aromatic polyester polyol compound comprises an average functionality ranging from about 1.5 to about 3.5, an average hydroxyl number ranging from about 30 to about 600, and an acid number ranging from about 0.1 to about 10, and has a resulting viscosity ranging from 200 to about 50,000 centipoises at about 25° C.

11. The method according to claim 1, wherein the esterification reaction conditions comprise reacting the reactive mixture at a temperature ranging from about 50° C. to about 300° C. for a period ranging from about 1 hour to about 24 hours.

12. The method according to claim 1, wherein the reactive mixture further comprises (vi) an esterification catalyst compound and wherein the esterification catalyst compound comprises about 0.001 to about 0.2% by weight based on the weight of the reactive mixture.

13. An aromatic polyester compound, wherein the aromatic polyester polyol compound is the reaction product of a reactive mixture comprising the following components:
(i) an aromatic acid compound;
(ii) an aliphatic diol compound;
(iii) a dialkylol alkanoic acid compound of Formula I: 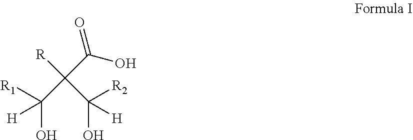
wherein R is hydrogen, C₁ to C₈ alkyl (straight-chain or branched), C₁ to C₈ hydroxyalkyl, C₁ to C₁₂ aromatic, or C₁ to C₁₂ cyclic aliphatic, and wherein R₁, R₂ are each independently hydrogen, C₁ to C₈ alkyl (straight-chain or branched); and
(v) optionally, a hydrophobic compound, a polyhydroxy compound comprising at least three hydroxyl groups, or combinations thereof; and
wherein the aromatic polyester polyol compound is liquid at 25° C. and has a hydroxy value ranging from about 30 to about 600.

14. The aromatic polyester polyol compound according to claim 13, wherein at least one of R₁ and R₂ is hydrogen.

15. The aromatic polyester polyol compound according to claim 13, wherein R is hydrogen, ethyl, methyl, hydroxymethyl, C₁-C₃ alkyl, or phenyl.

16. The aromatic polyester polyol compound according to claim 13, wherein Component (iii) comprises 2,2-bis(hydroxymethyl)propionic acid (DMPA); 2,2-bis(hydroxymethyl)butanoic acid (DMBA); 2,2-bis(hydroxymethyl)pentanoic acid (DMPTA); 2,2-bis(hydroxymethyl)hexanoic acid (DMHA); 2,2,2-trimethylol acetic acid (TMAA); and 2,2-bis(hydroxymethyl)phenylacetic acid and 2,2-bis(hydroxymethyl) tolylacetic acid; or combinations thereof.

17. The aromatic polyester polyol compound according to claim 13, wherein the aromatic polyester polyol has a bio-renewable content and/or recycled content of at least 10% by weight based on the total weight of the aromatic polyester polyol.

18. (canceled)

19. The aromatic polyester polyol compound according to claim 13, wherein the viscosity of the aromatic polyester polyol compound ranges from about 200 to about 150,000 centipoises at 25° C.

20. The aromatic polyester polyol compound according to claim 13, wherein the acid value of the aromatic polyester polyol compound ranges from about 0.1 mg of KOH/g to about 10 mg of KOH/g.

21. The aromatic polyester polyol compound according to claim 13, wherein the viscosity of the aromatic polyester polyol compound is lower than a corresponding polyol compound made to the same hydroxy number, aromatic content, and calculated functionality but without the use of Component (iii).

22. The aromatic polyester polyol compound according to claim 13, wherein the aromatic polyester polyol comprises an average functionality ranging from about 1.5 to about 3.5, an average hydroxyl number ranging from about 30 to about 600, and an acid number ranging from about 0.1 to about 10, and has a resulting viscosity ranging from 200 to about 50,000 centipoises at about 25° C.

23. A polyurethane foam composition comprising:
(a) an isocyanate compound;
(b) an aromatic polyester polyol compound that is the esterification reaction product of the following components:
(i) an aromatic acid compound;
(ii) an aliphatic diol compound;
(iii) a dialkylol alkanoic acid compound of Formula I: 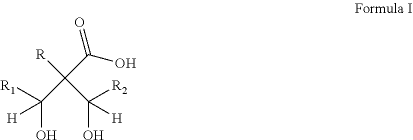
wherein R is hydrogen, C₁ to C₈ alkyl (straight-chain or branched), C₁ to C₈ hydroxyalkyl, C₁ to C₁₂ aromatic, or C₁ to C₁₂ cyclic aliphatic, and wherein R₁, R₂ are each independently hydrogen, C₁ to C₈ alkyl (straight-chain or branched); and
(iv) optionally, a hydrophobic compound, a polyhydroxy compound comprising at least three hydroxyl groups, or combinations thereof; and
wherein the aromatic polyester polyol compound is liquid at 25° C. and has a hydroxy value ranging from about 30 to about 600; and
(c) optionally, a blowing agent; and
(d) optionally, auxiliary compounds and additives.
